(19) United States
(12) Patent Application Publication
(10) Pub. No.: US 2004/0067782 A1
(43) Pub. Date: Apr. 8, 2004

(54) Installation of wireless local area network device into a laptop computer

(75) Inventors: Yaron Kagan, Kfar Yona (IL); Yossi Texerman, Modl'ln (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Envara Ltd.

(21) Appl. No.: 10/621,511

(22) Filed: Jul. 18, 2003

Related U.S. Application Data
(60) Provisional application No. 60/416,241, filed on Oct. 7, 2002.

(51) Int. Cl. H04M 1/00

(52) U.S. Cl. 455/575.1; 455/566

(57) ABSTRACT

A portable computer system, including a display cover, a lower housing, a hinge arrangement configured to mechanically connect the display cover and the lower housing, a processor disposed within the lower housing and a wireless communication device disposed within the display cover. The wireless communication device has an antenna. An Ethernet link at least partially defines a communication link between the processor and the wireless communication device.

### FIELD AND BACKGROUND OF THE INVENTION

The present invention relates to a wireless local area network device and, in particular, it concerns installation of a wireless local area network device into a laptop computer.

By way of introduction, wireless local area network (WLAN) devices enable laptop computers to establish a local area network and to communicate wirelessly with other computers via the WLAN devices. Each WLAN device has an antenna which is preferably installed in the display cover of the laptop computer so that when the display cover is open, the WLAN antenna is unobstructed, thereby enabling larger wireless coverage.

Of most relevance to the present invention is a prior art system whereby the WLAN device, without the antennas, is installed on the laptop motherboard and the antennas are installed in the display cover. RF cables are routed between the WLAN device on the motherboard and antennas in the display cover. A shortcoming of the aforementioned system is due to the high relative cost of RF cable. A further shortcoming of the aforementioned system is that there is a signal loss in the RF cable of several dB's.

Also of relevance to the present invention is a prior art system whereby the complete WLAN device, including antennas, is installed in the display cover. A USB interface is used to interconnect between the processor on the motherboard and the WLAN in the display cover. Routing of the USB interface cable between the motherboard and the display cover is simple and inexpensive. However, this implementation causes unnecessary power consumption, as the USB host must periodically poll all USB devices, although there may be no data to be received from that device as only a USB host can initiate data transfer.

There is therefore a need for an inexpensive, easy and energy efficient system to install a WLAN device antenna in a display cover of a laptop computer.

### SUMMARY OF THE INVENTION

The present invention is a system and method for providing a link between a processor on a motherboard and a WLAN device in a laptop computer.

According to the teachings of the present invention there is provided, a portable computer system, comprising: (a) a display cover; (b) a lower housing; (c) a hinge arrangement configured to mechanically connect the display cover and the lower housing; (d) a processor disposed within the lower housing; (e) a wireless communication device disposed within the display cover, the wireless communication device having an antenna; and (f) an Ethernet link at least partially defining a communication link between the processor and the wireless communication device.

According to a further feature of the present invention, the wireless communication device is a wireless local area network device.

According to a further feature of the present invention, there is also provided a wired Ethernet port which is operationally connected to the processor, wherein the processor is configured, such that, when the wired Ethernet port is active, the communication link between the processor and the wireless communication device is disconnected.

According to a further feature of the present invention, the Ethernet link is configured to actuate a power save mode of the wireless communication device when the wired Ethernet port is active.

According to a further feature of the present invention, there is also provided a wired Ethernet port which is operationally connected to the processor, wherein the Ethernet link is configured, such that, when the wired Ethernet port is active, the communication link between the processor and the wireless communication device is disconnected.

According to a further feature of the present invention, the Ethernet link includes a switch arrangement which is configured to disconnect the communication link between the processor and the wireless communication device when the wired Ethernet port is active.

According to a further feature of the present invention, the switch arrangement is configured to actuate a power save mode of the wireless communication device when the wired Ethernet port is active.

According to a further feature of the present invention, the switch arrangement includes an Ethernet switch.

According to a further feature of the present invention, the switch arrangement includes at least one analog switch.

According to a further feature of the present invention, the Ethernet link includes an energy detector configured to detect when the wired Ethernet port is active.

According to a further feature of the present invention, the Ethernet link includes a mechanically actuated switch configured to detect when the wired Ethernet port is connected to a wired local area network.

According to the teachings of the present invention there is also provided, a method for communicating between a processor of a computer system and a remote device, the computer system including a display cover, a lower housing, a hinge arrangement, an Ethernet link and a wireless communication device having an antenna, the hinge arrangement being configured to mechanically connect the display cover and the lower housing, the processor being disposed within the lower housing, the wireless communication device being disposed within the display cover, the Ethernet link being configured to at least partially define a communication link between the processor and the wireless communication device, the method comprising the steps of: (a) operationally connecting the processor and the wireless communication device via the Ethernet link; and (b) communicating between the computer system and the remote device via the wireless communication device.

According to a further feature of the present invention, there is also provided the step of disconnecting the communication ink between the processor and the wireless communication device when a wired Ethernet port of the computer system is active.

According to a further feature of the present invention, there is also provided the step of actuating a power save mode of the wireless communication device when a wired Ethernet port of the computer system is active.

According to a further feature of the present invention, there is also provided the step of detecting when a wired Ethernet port of the computer system is active.

### BRIEF DESCRIPTION OF THE DRAWINGS

The invention is herein described, by way of example only, with reference to the accompanying drawings, wherein:

FIG. 1 is a schematic view of an Ethernet link between a processor and a wireless communication device that is constricted and operable in accordance with a preferred embodiment of the invention;

FIG. 2 is a schematic view of an Ethernet link between a processor and a wireless communication device using a Dual Ethernet PHY that is constructed and operable in accordance with a first alternate embodiment of the invention,

FIG. 3 is a schematic view of an Ethernet link between a processor and a wireless communication device using an Ethernet switch that is constructed and operable in accordance with a second alternate embodiment of the invention;

FIG. 4 is a schematic view of an Ethernet link between a processor and a wireless communication device using an analogue switch and a energy detector that is constructed and operable in accordance with a third alternate embodiment of the invention; and

FIG. 5 is a schematic view of an Ethernet link between a processor and a wireless communication device using an analogue switch and a mechanically actuated switch that is constructed and operable in accordance with a fourth alternate embodiment of the invention.

### DESCRIPTION OF THE PREFERRED EMBODIMENTS

The present invention is a system and method for providing a link between a processor and a wireless communication device in a laptop computer. The principles and operation of a link between a processor and a wireless communication device in a laptop computer according to the present invention may be better understood with reference to the drawings and the accompanying description.

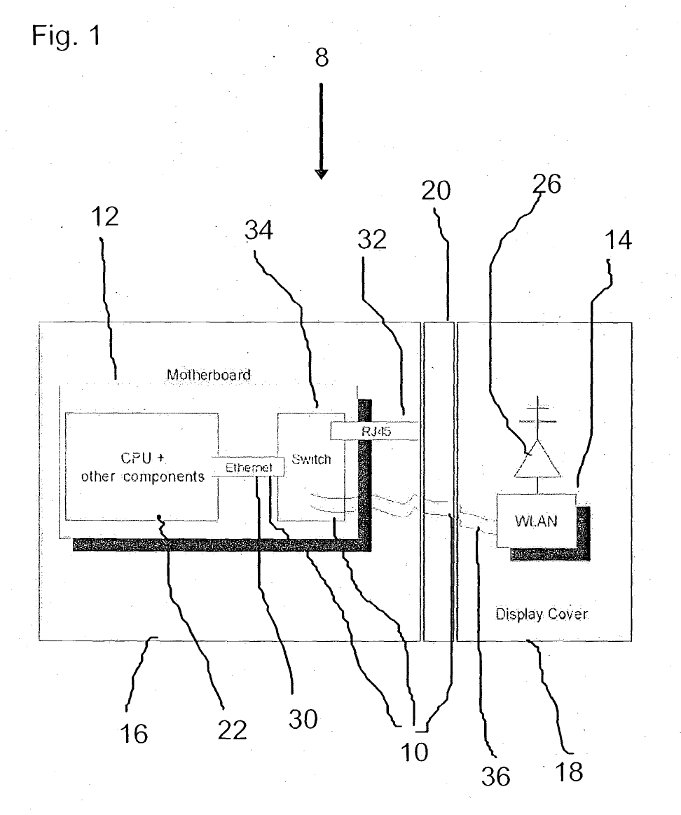

Reference is now made to FIG. 1, which is a schematic view of a portable computer system 8 having an Ethernet link 10( between a processor 22 and a wireless communication device 14 that is constructed and operable in accordance with a preferred embodiment of the invention. Computer system 8 is typically a laptop computer having a lower housing 16, a display cover 18 and a hinge arrangement 20, hinge arrangement 20 being configured to mechanically connect lower housing 16 and display cover 18. Computer system 8 includes processor 22 which is disposed on a motherboard 12 within lower housing 16. Processor 22 includes the central processing unit and supporting core logic chips of computer system 8. Wireless communication device 14 is disposed within display cover 18. Wireless communication device 14 is typically a WLAN device. Wireless communication device 14 has one or more antennas 26. Ethernet link 10 is configured so as to at least partially define a communication link between processor 22 and wireless communication device 14. Therefore, operationally connecting processor 22 and wireless communication device 14 via Ethernet link 10 enables computer system 8 to communicate with one or more remote devices via wireless communication device 14. Part of Ethernet link 10 is disposed within lower housing 16 and part of Ethernet link 10 is disposed within display cover 18. Ethernet link 10 includes an Ethernet cable 36 which extends from lower housing 16 to display cover 18. Additionally, other Ethernet devices are needed to form Ethernet link 10. It will be apparent to those ordinarily skilled in the art that Ethernet link 10 can be formed using a variety of Ethernet components and devices.

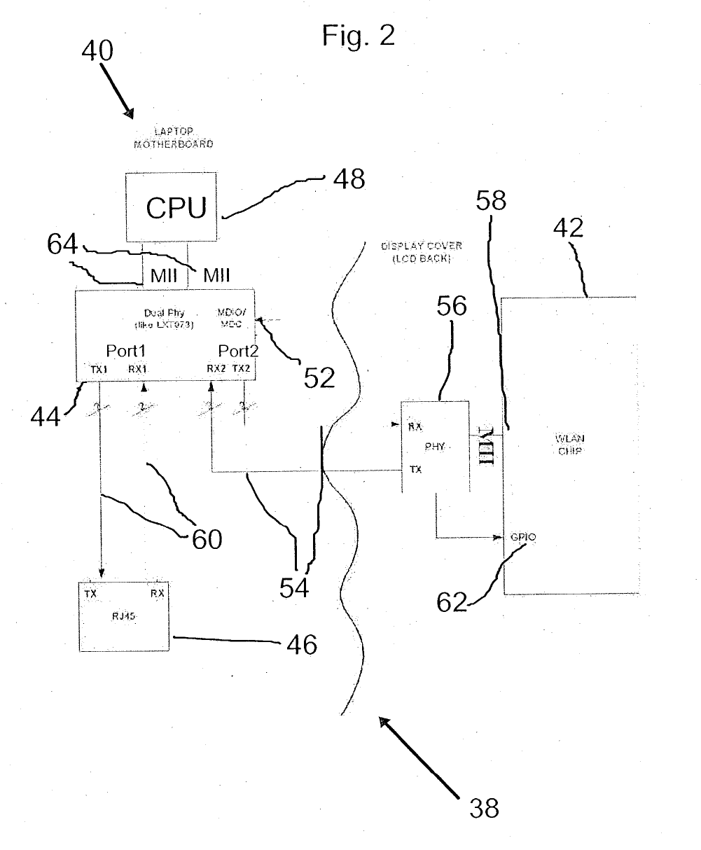

The system of the present invention has the advantage of wireless communication device 14 and antennas 26 being disposed in display cover 18, so that when the display cover 18 is open, antennas 26 are unobstructed, thereby enabling larger wireless coverage. Additionally, the interconnection between processor 22 and wireless communication device 14 is via Ethernet link 10. Using the mature and proven Ethernet technology to interconnect between processor 22 and wireless communication device 14 which is disposed in display cover 18, results in a simple, inexpensive and high performing overall implementation. Moreover, all advanced laptop computers, currently under design or production, include built-in support for both wired (such as IEEE 802.3 Ethernet) and wireless (such as IEEE 802.11 a or b or g) connection to a local area network (LAN). Wired (standard) Ethernet interface 30 is generally connected to a wired LAN port 32 having an RJ45 socket for connection to a wired LAN. The wireless LAN connection is typically provided via all interface (not shown) to a wireless communication device, such as a WLAN device. The laptops are generally configured so that either wired (standard) Ethernet interface 30 or the wireless interface is active at a certain time. Therefore, the Ethernet link 10 of the present invention can be configured to include at least part of existing wired (standard) Ethernet interface 30, which is located on motherboard 12. Ethernet link 10 also includes a switching system 34 which routes data from processor 22 either to wired LAN port 32 when wired LAN port 32 is active, or to wireless communication device 14 when wired LAN port 32 is inactive. Alternate embodiments of switching system 34 are described below with reference to FIGS. 2 to 5. Additionally, Ethernet link 10 and/or processor 22 is configured to actuate a power save mode of wireless communication device 14 when wired LAN port 32 is active. This aspect of the invention is described in more detail with reference to FIGS. 2 to 5.

Using Ethernet link 10 between processor 22 and wireless communication device 14 has the following advantages: (i) a low number of interconnecting wires, typically 2 analogue pairs; (ii) the length of Ethernet cable 36 does not distort or attenuate the signal, as compared with an RF cable connection; (iii) Ethernet is a well known, commonly used and low cost technology and (iv) wireless communication device 14 is maintained in a power save mode when wired LAN port 32 is active.

Reference is now made to FIG. 2, which is a schematic view of an Ethernet link 38 between a processor 48 and a wireless communication device 42 using a dual Ethernet PHY chip 44 that is constructed and operable in accordance with a first alternate embodiment of the invention. Ethernet link 38 defines a communication link between processor 48 which is installed on a motherboard 40 and wireless communication device 42. Wireless communication device 42 is typically a WLAN device. Ethernet link 38 includes two analogue pairs 54, dual Ethernet PHY chip 44 and an Ethernet PHY chip 56. Dual Ethernet PHY chip 44 is disposed on motherboard 40. Dual Ethernet PHY chip 44 is operationally connected to processor 48 via two MII connections 64. Analogue pairs 54 connect Port2 of dual Ethernet PHY chip 44 to Ethernet PHY chip 56. Ethernet PHY chip 56 is operationally connected to wireless communication device 42 via an MII connection 58. A wired Ethernet port 46 is operationally connected to Port1 of dual Ethernet PHY chip 44 using two analogue pairs 60. Dual Ethernet PHY chip 44 supports the connection between processor 48 and wired Ethernet port 46 as well as the connection between processor 48 and wireless communication device 42. An example of a suitable dual Ethernet PHY chip 44 is LXT973, which is commercially available for Intel Corporation of 2200 Mission College Blvd., Santa Clara, Calif. 95052, USA. It will be appreciated by those skilled in the art that dual Ethernet PHY chip 44 may be replaced by two suitable single PHY chips. Either wired Ethernet port 46 or wireless communication device 42 is operational at one time under the control of processor 48 through a MDIO interface 52 of dual Ethernet PHY chip 44. Processor 48 is configured, typically by software running thereon, to sense when wired Ethernet port 46 is active or inactive. When wired Ethernet port 46 is active, processor 48 actuates dual Ethernet PHY chip 44 to disconnect the communication link between processor 48 and wireless communication device 42 by disconnecting Port2 of dual Ethernet PHY chip 44. Ethernet PHY chip 56 of Ethernet link 38 is configured to sense the disconnection of Port2 of dual Ethernet PHY chip 44 and thereby force the remaining part of wireless communication device 42 to enter a power save mode via a GPIO (general purpose in/out) interface 62 of wireless communication device 42.

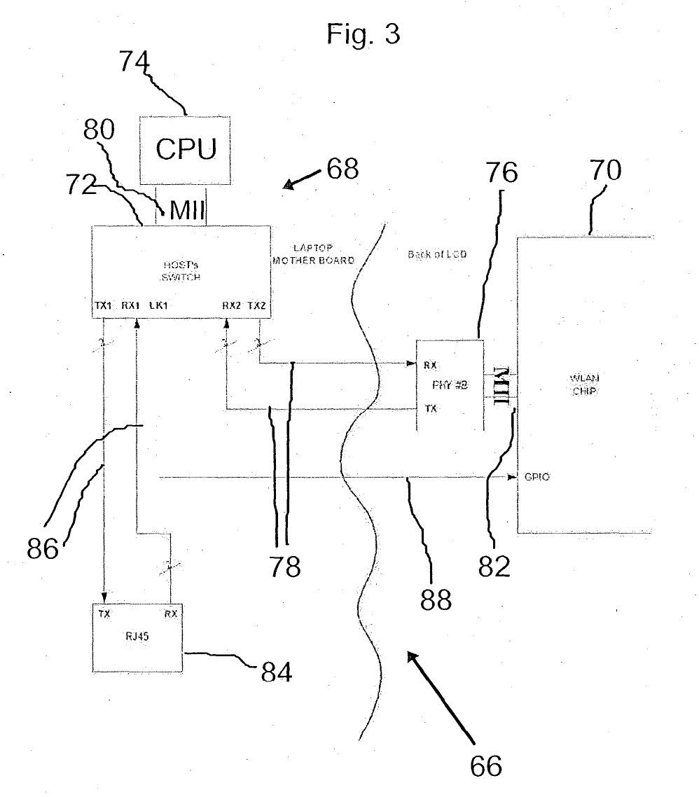

Reference is now made to FIG. 3, which is a schematic view of an Ethernet link 66 between a processor 74 and a wireless communication device 70 using a switch arrangement, Ethernet switch 72, that is constructed and operable in accordance with a second alternate embodiment of the invention. Processor 74 is installed on a motherboard 68. Ethernet link 66 includes Ethernet switch 72, an Ethernet PHY chip 76 and two analogue pairs 78. Ethernet switch 72 is disposed on motherboard 68 and is operationally connected to processor 74 via an MII connection 80. Analogue pairs 78 connect Port2 of Ethernet switch 72 to Ethernet PHY chip 76. Ethernet PHY chip 76 is connected to wireless communication device 70 via an MII connection 82. A digital line 88 connects the LK1 port of Ethernet switch 72 to the GPIO port of wireless communication device 70. A wired Ethernet port 84 having an RJ45 socket is connected to Port1 of Ethernet switch 72 via two analogue pairs 86. Ethernet switch 72 supports both the connection between processor 74 and wired Ethernet port 84 as well as the connection between processor 74 and wireless communication device 70. Ethernet switch 72 works in an unmanaged operation via strapping at system-reset time. When Port1 of Ethernet switch 72 senses that wired Ethernet port 84 is active, Ethernet switch 72 is configured to disconnect the communication link between processor 74 and wireless communication device 70 by disconnecting Port2 of Ethernet switch 72. Additionally, when Port1 of Ethernet switch 72 senses that wired Ethernet port 84 is active, Ethernet switch 72 deactivates wireless communication device 70, actuating a power save mode of wireless communication device 70, by sending a signal from the LK1 port of Ethernet switch 72 to the GPIO port of Wireless communication device 70. Wireless communication device 70 remains in power save mode until Port1 of Ethernet switch 72 no longer senses activity from wired Ethernet port 84. Upon activation of Port2, a signal from the LK1 of Ethernet switch 72 is used to awaken wireless communication device 70. An example of a suitable Ethernet switch 72 is KS8993, which is commercially available from Kendin Communications, Inc. of 486 Mercury Drive, Sunnyvale, Calif. 94086, USA.

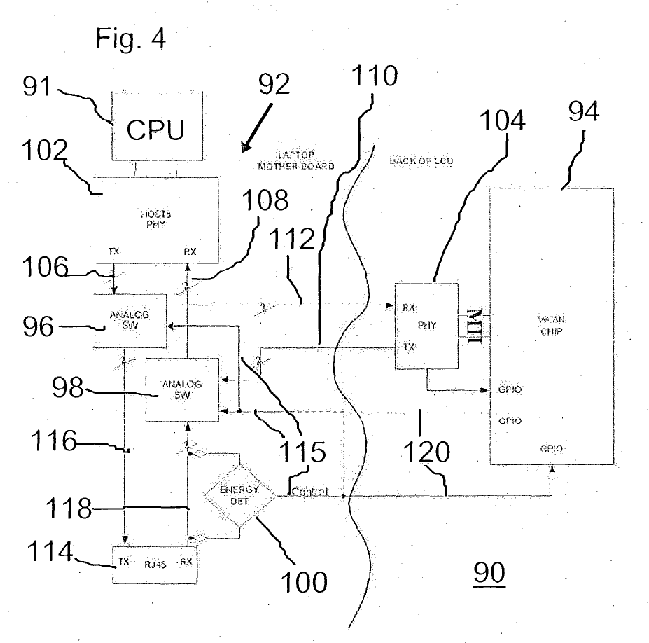

Reference is now made to FIG. 4, which is a schematic view of an Ethernet, link 90 between a processor 91 and a wireless communication device 94 having a switch arrangement, the switch arrangement including two analogue switches 96, 98 and an energy detector 100 that is constructed and operable in accordance with a third alternate embodiment of the invention. Processor 91 is installed on a motherboard 92. Ethernet link 90 includes a standard single Ethernet PHY chip 102 which is connected to processor 91. Ethernet link 90 also includes a standard Ethernet PHY chip 104 which is connected to wireless communication device 94. The TX port of Ethernet PHY chip 102 is connected to analogue switch 96 via an analogue pair 106. The RX port of Ethernet PHY chip 102 is connected to analogue switch 98 via an analogue pair 108. The TX port of Ethernet PHY chip 104 is connected to analogue switch 98 via an analogue pair 110. The RX port of Ethernet PHY chip 104 is connected to analogue switch 96 via an analogue pair 112. The TX connection of a wired Ethernet port 114 is connected to analogue switch 96 via an analogue pair 116. The RX connection of wired Ethernet port 114 is connected to analogue switch 98 via an analogue pair 118. Analogue switch 96 is either implemented as two switches or a single differential switch. Analogue switch 96 is configured to route the TX signal from Ethernet PHY chip 102 to either Ethernet PHY chip 104 or wired Ethernet port 114. Similarly, analogue switch 98 is configured to route the RX signal from wired Ethernet port 114 to Ethernet PHY chip 102 or the TX signal from Ethernet PHY chip 104 to Ethernet PHY chip 102. Analogue switch 96 and analogue switch 98 are controlled by energy detector 100, which senses when wired Ethernet port 114 is active. When energy detector 100 senses the existence of an active RX signal of wired Ethernet port 114, energy detector 100 provides a control signal to analogue switch 96 and analogue switch 98 via a control line 115 thereby connecting Ethernet PHY chip 102 to Ethernet PHY chip 104. Typically, Ethernet PHY chip 104 is configured to sense the disconnection of Ethernet PHY chip 104 from Ethernet PHY chip 102 and thereby force the wireless communication device 94 to enter a power save mode via a GPIO interface of wireless communication device 94. Alternatively, wireless communication device 94 is forced into a power save mode by energy detector 100 sending a signal to a GPIO port of wireless communication device 94 via one or two digital control lines 120.

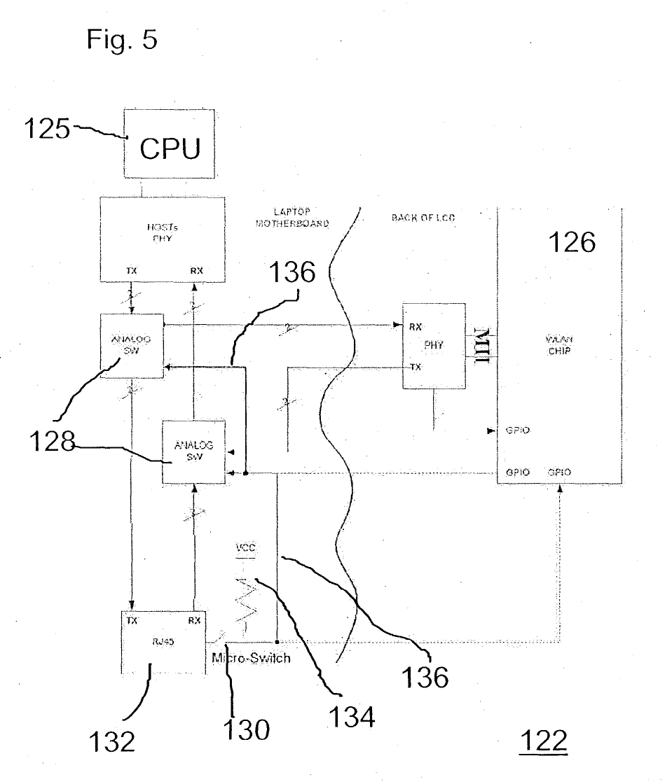

Reference is now made to FIG. 5, which is a schematic view of an Ethernet link 122 between a processor 125 and a wireless communication device 126 using a switch arrangement, the switch arrangement including two analogue switches 128 and a mechanically actuated switch 130 that is constructed and operable in accordance with a fourth alternate embodiment of the invention. The switch arrangement establishes either a connection between processor 125 and wireless communication device 126 or a connection between processor 125 and a wired Ethernet port 132 having an RJ45 socket. The embodiment described with reference to FIG. 5 is substantially the same as the embodiment described with reference to FIG. 4 except that energy detector 100 of FIG. 4 is replaced by mechanically actuated switch 130. Mechanically actuated switch 130 is configured to detect when the RJ45 socket of wired Ethernet port 132 is connected to a wired local area network via an RJ45 plug (not shown). When the RJ45 plug is inserted into the RJ45 socket of wired Ethernet port 132, the RJ45 plug actuates mechanically actuated switch 130. When the RJ45 plug is connected to wired Ethernet port 132, a logic level “0” is held on a control line 136, such that, wireless communication device 126 is disconnected from processor 125 and wired Ethernet port 132 is connected to processor 125. When the RJ45 plug is removed from the RJ45 socket of wired Ethernet port 132, mechanically actuated switch 130 is released and a pull up resistor 134 provides a logic level “1” on control line 136, such that, wireless communication device 126 is connected to processor 125 and wired Ethernet port 132 is disconnected from processor 125.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A portable computer system, comprising:
(a) a display cover;
(b) a lower housing;
(c) a hinge arrangement configured to mechanically connect said display cover and said lower housing;
(d) a processor disposed within said lower housing;
(e) a wireless communication device disposed within said display cover, said wireless communication device having an antenna; and
(f) an Ethernet link at least partially defining a communication link between said processor and said wireless communication device.

2. The system of claim 1, wherein said wireless communication device is a wireless local area network device.

3. The system of claim 1, further comprising:
(g) a wired Ethernet port which is operationally connected to said processor, wherein said processor is configured, such that, when said wired Ethernet port is active, said communication link between said processor and said wireless communication device is disconnected.

4. The system of claim 3, wherein said Ethernet link is configured to actuate a power save mode of said wireless communication device when said wired Ethernet port is active.

5. The system of claim 1, further comprising:
(g) a wired Ethernet port which is operationally connected to said processor, wherein said Ethernet link is configured, such that, when said wired Ethernet port is active, said communication link between said processor and said wireless communication device is disconnected.

6. The system of claim 5, wherein said Ethernet link includes a switch arrangement which is configured to disconnect said communication link between said processor and said wireless communication device when said wired Ethernet port is active.

7. The system of claim 6, wherein said switch arrangement is configured to actuate a power save mode of said wireless communication device when said wired Ethernet port is active.

8. The system of claim 6, wherein said switch arrangement includes an Ethernet switch.

9. The system of claim 6, wherein said switch arrangement includes at least one analog switch.

10. The system of claim 6, wherein said Ethernet link includes an energy detector configured to detect when said wired Ethernet port is active.

11. The system of claim 6, wherein said Ethernet link includes a mechanically actuated switch configured to detect when said wired Ethernet port is connected to a wired local area network.

12. A method for communicating between a processor of a computer system and a remote device, the computer system including a display cover, a lower housing, a hinge arrangement, an Ethernet link and a wireless communication device having an antenna, the hinge arrangement being configured to mechanically connect the display cover and the lower housing, the processor being disposed within the lower housing, the wireless communication device being disposed within the display cover, the Ethernet link being configured to at least partially define a communication link between the processor and the wireless communication device, the method comprising the steps of:
(a) operationally connecting the processor and the wireless communication device via the Ethernet link; and
(b) communicating between the computer system and the remote device via the wireless communication device.

13. The method of claim 12, further comprising the step of:
(c) disconnecting the communication link between the processor and the wireless communication device when a wired Ethernet port of the computer system is active.

14. The method of claim 12, further comprising the step of:
(c) actuating a power save mode of the wireless communication device when a wired Ethernet port of tile computer system is active.

15. The method of claim 12, further comprising the step of:
(c) detecting when a wired Ethernet port of the computer system is active.
